(19) United States
(12) Patent Application Publication
(10) Pub. No.: US 2021/0291860 A1
(43) Pub. Date: Sep. 23, 2021

(54) DRIVING ASSISTANCE SYSTEM AND DRIVING ASSISTANCE PROGRAM

(71) Applicants: AISIN AW CO., LTD., Anjo-shi (JP); TOYOTA JIDOSHA KABUSHIKI KAISHA, Toyota-shi (JP)

(72) Inventors: Yoshito KONDO, Anjo-shi (JP); Shingo KINASHI, Anjo-shi (JP); Hironobu SUGIMOTO, Nagoya-shi (JP); Akira IIJIMA, Nagoya-shi (JP); Yohei KUBO, Toyota-shi (JP)

(73) Assignees: AISIN AW CO., LTD., Anjo-shi (JP); TOYOTA JIDOSHA KABUSHIKI KAISHA, Toyota-shi (JP)

(21) Appl. No.: 17/200,064

(22) Filed: Mar. 12, 2021

(30) Foreign Application Priority Data
Mar. 23, 2020 (JP) 2020-050576

(51) Int. Cl. B60W 60/00; G01C 21/36; B60W 50/14

(52) U.S. Cl. CPC B60W 60/005; B60W 2050/146; B60W 50/14; G01C 21/3697

(57) ABSTRACT

A driving assistance system includes a planned travel route acquirer, a driving assistance section acquirer, and a guide controller. The planned travel route acquirer acquires a planned travel route for a vehicle. The driving assistance section acquirer acquires a driving assistance section on the planned travel route. The guide controller presents at least one icon indicating a point of switching between the driving assistance section and a non-assistance section on the planned travel route.

This application claims the benefit of priority from Japanese Patent Application No. 2020-050576 filed on Mar. 23, 2020, the specification, drawings and abstract of which are incorporated herein by reference in their entirety.

### BACKGROUND

The present disclosure relates to driving assistance systems and driving assistance programs.

### DESCRIPTION OF THE RELATED ART

A technique known in the related art involves, when presenting a planned travel route on a map, presenting an automatic driving section and a non-automatic driving section on the planned travel route distinctively (see, for example, paragraph 0056 of Japanese Unexamined Patent Application Publication No. 2015-141478 (JP 2015-141478 A)).

### SUMMARY OF THE DISCLOSURE

A navigation device presents roads on a map such that various pieces of information (such as distinctions between planned travel routes and routes other than the planned travel routes, road types, and traffic information) are expressed using, for example, lines of different colors, thicknesses, and/or line types. In one specific example, a known approach to presenting a congested section and a restricted section of a road involves presenting, along the road, lines whose colors and line types are responsive to the degree of traffic congestion and the details of restrictions. JP 2015-141478 A discloses a technique to present an automatic driving section and a non-automatic driving section distinctively by using different line types. Accordingly, one approach may involve not only presenting lines whose various colors and line types are indicative of the degree of traffic congestion and the details of, for example, restrictions, but also presenting, on a road or on the side of a road, lines to make a distinction between a driving assistance section and a non-assistance section. Such an approach, however, excessively increases the amount of information to be expressed on the road or on the side of the road using the lines. This unfortunately makes it difficult for a user to understand a point of switching between the driving assistance section and the non-assistance section.

Aspects of the present disclosure have been made in view of the above problems, and an aspect of the present disclosure is to provide a technique to increase the possibility of easily understanding a point of switching between a driving assistance section and a non-assistance section.

According to an aspect, a driving assistance system includes a planned travel route acquirer, a driving assistance section acquirer, and a guide controller. The planned travel route acquirer acquires a planned travel route for a vehicle. The driving assistance section acquirer acquires a driving assistance section on the planned travel route. The guide controller presents at least one icon indicating a point of switching between the driving assistance section and a non-assistance section on the planned travel route.

According to an aspect, a driving assistance program causes a computer to function as a planned travel route acquirer, a driving assistance section acquirer, and a guide controller. The planned travel route acquirer acquires a planned travel route for a vehicle. The driving assistance section acquirer acquires a driving assistance section on the planned travel route. The guide controller presents at least one icon indicating a point of switching between the driving assistance section and a non-assistance section on the planned travel route.

The driving assistance system and the driving assistance program present an icon indicating a point of switching between a driving assistance section and a non-assistance section, thus guiding a user to the location of the point of switching. The icon is visually different from lines presentable on a planned travel route and/or on the side of the planned travel route in various presentation modes. The user is thus able to easily distinguish the icon from the lines. Accordingly, the driving assistance system and the driving assistance program are able to make it more likely for the user to easily understand that the position indicated by the icon is a point of switching between the driving assistance section and the non-assistance section.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a block diagram illustrating a configuration of a navigation system;

FIGS. 2A, 2B, and 2C are diagrams each illustrating examples of icons indicating points of switching between a driving assistance section and a non-assistance section on a planned travel route; and

FIG. 3 is a flow chart of a driving assistance section presenting process.

### DETAILED DESCRIPTION OF THE EMBODIMENTS

Embodiments of the present disclosure will be described below in the following order:

(1) Configuration of Navigation System;

(2) Driving Assistance Section Presenting Process; and

(3) Other Embodiments.

### (1) Configuration of Navigation System

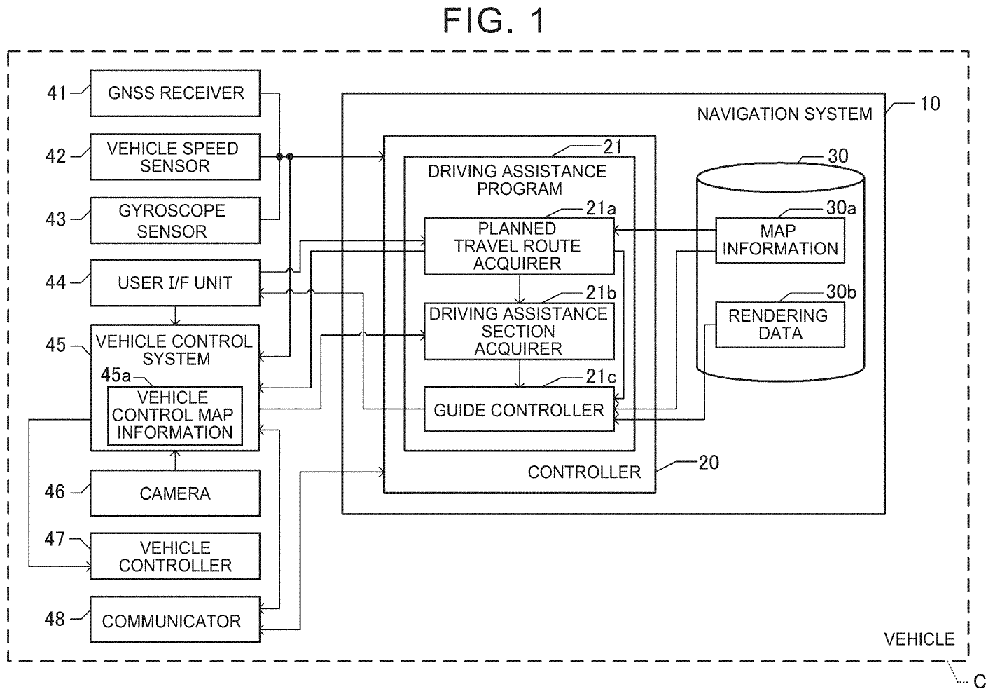

FIG. 1 is a block diagram illustrating a configuration of a navigation system 10 according to an embodiment of the present disclosure. The navigation system 10 functions as a driving assistance system. The navigation system 10 is installed in a vehicle C. The vehicle C is drivable manually by a driver and drivable under driving assistance control by a vehicle control system 45. In accordance with, for example, the degree of driver's involvement in driving, Levels 0 to 5 are defined for driving assistance and automatic driving. Level 0 denotes that all of driving operations are to be performed by the driver. In other words, Level 0 denotes manual driving. Level 1 and subsequent levels denote reductions in the need for driver's involvement in driving operations. The higher the level, the lower the need for driver's involvement in driving operations.

In general, Levels 1 and 2 are referred to as “driving assistance”, and Levels 3, 4, and 5 are referred to as “automatic driving”. A road section in which a predetermined level of driving assistance control is exercisable will herein be referred to as a “driving assistance section”. A road section in which the predetermined level of driving assistance control is not exercisable (i.e., a section in which the need for driver's involvement in driving operations is greater than the predetermined level) will herein be referred to as a “non-assistance section”. As used herein, the term “driving assistance section” may refer to a section in which automatic driving control is to be exercised. As used herein, the term “non-assistance section” may refer to a section in which a system aids the driver in steering, accelerating, and decelerating the vehicle C.

The present embodiment is based on the assumption that the predetermined level is Level 3. The driving assistance section is assumed to be, for example, an expressway. In the present embodiment, driving assistance control in the driving assistance section is thus assumed to be exercised for automatic driving (automated driving operations) mainly in an expressway road section. If the vehicle C is traveling in the driving assistance section, the vehicle C would be controlled in accordance with a driving operation when the driving operation is performed by the driver. The present embodiment is based on the assumption that the driver plays a main role in performing driving operations in the non-assistance section. The driving operations in this case include, for example, fully manual driving, and driving operations to be performed while the driver receives support for steering, acceleration, and deceleration. In other embodiments, the predetermined level is naturally not limited to Level 3 but may be any other suitable level, and the driving assistance section is naturally not limited to an expressway.

Road sections included in map information include a driving assistance section (i.e., a road section in which the predetermined level of driving assistance control is exercisable) determined in advance. The vehicle C is able to acquire information on the driving assistance section from a server (not illustrated). The driving assistance section may naturally change dynamically in accordance with the weather, road conditions, or other factors.

The vehicle C according to the present embodiment includes a GNSS receiver 41, a vehicle speed sensor 42, a gyroscope sensor 43, a user I/F unit 44, the vehicle control system 45, a camera 46, a vehicle controller 47, and a communicator 48.

The GNSS receiver 41 is a device to receive a signal from a global navigation satellite system. The GNSS receiver 41 receives a radio wave from a navigation satellite so as to output a signal for calculation of the current position of the vehicle through an interface (not illustrated). A controller 20 receives this signal so as to acquire the current position of the vehicle. The vehicle speed sensor 42 outputs a signal responsive to the rotation speed of the wheel(s) of the vehicle. The controller 20 receives this signal through an interface (not illustrated) so as to acquire a vehicle speed. The gyroscope sensor 43 detects an angular acceleration for a turn of the vehicle within a horizontal plane so as to output a signal responsive to the orientation of the vehicle. The controller 20 receives this signal so as to acquire the travel direction of the vehicle. Sensors, such as the vehicle speed sensor 42 and the gyroscope sensor 43, are used to determine the travel path of the vehicle. The present embodiment involves: determining the current position in accordance with the departure point and travel path of the vehicle; and correcting the current position of the vehicle (which has been determined in accordance with the departure point and travel path) in accordance with the signal output from the GNSS receiver 41.

The user I/F unit 44 is an interface to receive an instruction from a user and provide various pieces of information to the user. The user I/F unit 44 includes, for example, a touch screen display (not illustrated), a switch (not illustrated), and/or a speaker (not illustrated). Specifically, the user I/F unit 44 includes an output unit to output an image and/or a sound, and an input unit to receive an instruction from the user.

The communicator 48 is a communication circuit for wireless communication with a server (not illustrated). The server communicates with the vehicle C through the communicator 48. The server includes a map server. The map server is a server to manage, update, and/or distribute map information 30a for the navigation system 10 and vehicle control map information 45a stored in the vehicle control system 45. The vehicle C communicates with the map server through the communicator 48. The vehicle C is thus able to receive and update the map information 30a and the vehicle control map information 45a.

The vehicle control system 45 is a computer to control driving of the vehicle C. The vehicle control system 45 is connected to the vehicle controller 47. The vehicle controller 47 includes various actuators to control, for example, a steering system, an accelerator, and a brake. A recording medium (not illustrated) of the vehicle control system 45 records the vehicle control map information 45a. The vehicle control map information 45a is used when the vehicle control system 45 exercises driving assistance control.

The vehicle control map information 45a includes, for example, link association information, lane data, road marking paint data, and driving assistance availability information. The link association information indicates relationships between links defined in the map information 30a and road sections included in the vehicle control map information 45a. The lane data includes data indicative of lane structures and/or lane shapes for the associated links. The road marking paint data includes data indicative of locations to which road marking paint is applied and/or the details of the locations.

The driving assistance availability information indicates whether the target road section is a road section in which the predetermined level of driving assistance control is exercisable. More specifically, the driving assistance availability information is set for each road section defined in the vehicle control map information 45a and includes a value indicative of whether the target road section is a road section in which the predetermined level of driving assistance control is exercisable. In one example, the value is 1 when the predetermined level of driving assistance control is exercisable, and the value is 0 when the predetermined level of driving assistance control is not exercisable. Separators between the road sections in the vehicle control map information 45a may or may not correspond to endpoints (i.e., nodes) of the links in the map information 30a. Accordingly, the starting points and end points of driving assistance sections may or may not correspond to the nodes in the map information 30a.

Upon acquiring a planned travel route from the navigation system 10, the vehicle control system 45 determines, in accordance with the link association information, road sections included in the vehicle control map information 45a and associated with links included in the planned travel route. The vehicle control system 45 notifies the navigation system 10 about the driving assistance availability information on the road sections determined. Upon being notified about the driving assistance availability information on the road sections included in the planned travel route, the navigation system 10 determines a driving assistance section and a non-assistance section on the planned travel route as will be described blow.

When the vehicle C travels a driving assistance section and the driver performs no driving operation, the vehicle control system 45 controls the vehicle controller 47 in accordance with the vehicle control map information 45a and outputs from the GNSS receiver 41, the vehicle speed sensor 42, the gyroscope sensor 43, the camera 46, and various other sensors (not illustrated). The vehicle control system 45 thus exercises driving assistance control (which is automatic driving control in the present embodiment) for the vehicle C. If the vehicle C travels a driving assistance section, the vehicle control system 45 would control the vehicle controller 47 in response to a driver's driving operation when the driving operation is performed by the driver.

When the vehicle C travels a non-assistance section, the vehicle control system 45 controls the vehicle controller 47 mainly in response to a driver's driving operation, thus exercising control (such as following distance keeping control and/or lane keeping control) in accordance with, for example, a driver's instruction and/or predetermined settings in the present embodiment. When the vehicle C has travelled a driving assistance section under automatic driving control and has reached the end point of the driving assistance section (i.e., a point of switching from the driving assistance section to a non-assistance section that is a next road section), the vehicle control system 45 ends the automatic driving control and then controls the vehicle controller 47 mainly in response to a driver's driving operation.

The camera 46 is an image sensor to capture an image of a scenery in front of the vehicle C and/or an image of a scenery behind the vehicle C. The vehicle control system 45 performs an image recognition process on the image of the scenery in front of the vehicle C and/or the image of the scenery behind the vehicle C (which have/has been captured by the camera 46), thus recognizing (or detecting) an object on a road and/or on the periphery of the road. Specifically, the vehicle control system 45 recognizes image(s) of object(s), such as a lane dividing line, road marking paint, and/or a landmark feature, in accordance with the image of the scenery in front of the vehicle C and/or the image of the scenery behind the vehicle C. The vehicle control system 45 acquires the position of the vehicle C equipped with the camera 46 in accordance with: the position(s) of the lane dividing line, the road marking paint, and/or the landmark feature recognized within the image of the scenery in front of the vehicle C and/or the image of the scenery behind the vehicle C; and the position(s) of the lane dividing line, the road marking paint, and/or the landmark feature within an actual space. The position(s) of the lane dividing line, the road marking paint, and/or the landmark feature within the actual space are/is acquirable from the vehicle control map information 45a.

The navigation system 10 includes the controller 20 and a recording medium 30. The controller 20 includes, for example, a CPU, a RAM, and/or a ROM. The navigation system 10 is able to cause the controller 20 to execute programs stored in the recording medium 30 and/or the ROM. The programs to be executed by the controller 20 include a driving assistance program 21.

The recording medium 30 records the map information 30a and rendering data 30b in advance. The controller 20 is able to update the map information 30a in accordance with map information acquired by communication with the map server (not illustrated) through the communicator 48. The map information 30a is map data to be used for a route search and/or a route guide. The map information 30a includes: node data indicative of, for example, the positions of nodes set on roads on which the vehicle travels; a shape interpolation point data indicative of, for example, the positions of shape interpolation points by which the shapes of roads between the nodes are determined; link data indicative of links between the nodes; and feature data indicative of features present on roads and/or on the peripheries of roads. In the present embodiment, the nodes indicate intersections. The link data includes data indicative of, for example, road types, widths of roads, and the number of lanes. The feature data includes data indicative of the names, categories, locations, and/or shapes of facilities.

The rendering data 30b is data to render, for example, features (e.g., roads and facilities), characters, and/or icons on a map. The rendering data 30b includes rendering data that defines the shape of an icon indicating the starting point of a driving assistance section, and the shape of an icon indicating the end point of the driving assistance section. The controller 20 makes reference to the rendering data 30b so as to present a map, which includes a planned travel route, on the display of the user I/F unit 44.

The controller 20 is able to execute a navigation program (not illustrated) and is thus able to execute the driving assistance program 21, which is one of the functions of the navigation program. The driving assistance program 21 is a program to present a driving assistance section and a non-assistance section on a planned travel route in a distinguishable manner so as to prompt the driver to recognize the driving assistance section and the non-assistance section, thus carrying out the function of assisting the driver. To carry out this function, the driving assistance program 21 includes a planned travel route acquirer 21a, a driving assistance section acquirer 21b, and a guide controller 21c.

The planned travel route acquirer 21a is a program module to cause the controller 20 to carry out the function of acquiring a planned travel route for the vehicle. Specifically, a function of the planned travel route acquirer 21a causes the controller 20 to receive a destination entered by the user through the input unit of the user I/F unit 44 and make a search for a route from the current position of the vehicle to the destination in accordance with the map information 30a. The controller 20 thus acquires a planned travel route.

The driving assistance section acquirer 21b is a program module to cause the controller 20 to carry out the function of acquiring a driving assistance section on the planned travel route. A function of the driving assistance section acquirer 21b causes the controller 20 to notify the vehicle control system 45 about the planned travel route so as to acquire, from the vehicle control system 45, driving assistance availability information on road sections included in the planned travel route. In accordance with the driving assistance availability information, the controller 20 acquires the positions of the starting point and end point of the driving assistance section on the planned travel route. For example, suppose that the predetermined level of driving assistance control is exercisable for a plurality of continuous road sections. In this case, the controller 20 regards a section including the plurality of continuous road sections as a single driving assistance section. A point of switching from a non-assistance section to the driving assistance section is the starting point of the driving assistance section. A point of switching from the driving assistance section to a non-assistance section is the end point of the driving assistance section.

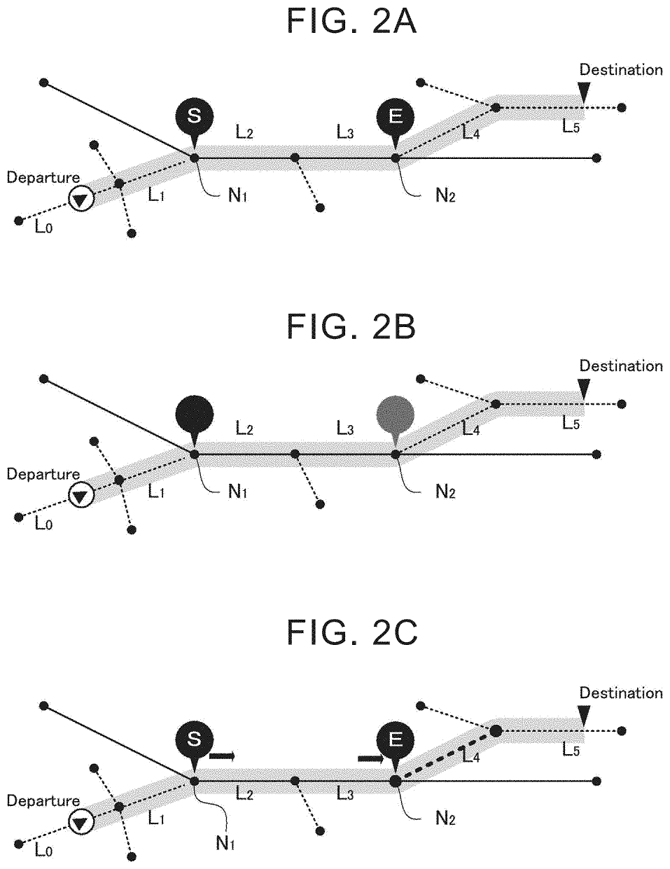

FIGS. 2A to 2C are diagrams each illustrating an example of a planned travel route. FIGS. 2A to 2C each illustrate the planned travel route and connecting relationships between links around the planned travel route. In each of the examples, the starting point and end point of a driving assistance section correspond to the associated nodes in the map information 30a. In FIGS. 2A to 2C, black dots indicate the nodes, and line segments connecting the nodes indicate the links. Each line segment represented as a solid line indicates that the link is a driving assistance section. Each line segment represented as a broken line indicates that the link is a non-assistance section. In each of FIGS. 2A to 2C, a gray thick line indicates the planned travel route. On the planned travel route illustrated in each of FIGS. 2A to 2C, links L₂ and L₃ define a driving assistance section, and links Lo, L₁, L₄, and L₅ define a non-assistance section. For example, the links L₂ and L₃ may be assumed to be a main lane of an expressway, the links Lo and L₅ may be assumed to be an ordinary road, and the links L₁ and L₄ may be assumed to be a rampway. In the examples illustrated in FIGS. 2A to 2C, the vehicle travels the planned travel route in the following order: the links Lo, L₁, L₂, L₃, L₄, and L₅. The controller 20 follows the links of the planned travel route in the order just mentioned so as to acquire a node N₁ and a node N₂ in accordance with the driving assistance availability information. The node N₁ is the starting point of a driving assistance section. In other words, the node N₁ is a point of switching from a non-assistance section to the driving assistance section. The node N₂ is the end point of the driving assistance section. In other words, the node N₂ is a point of switching from the driving assistance section to a non-assistance section.

In presenting a map, which includes a planned travel route, on the touch screen display of the user I/F unit 44, a typical approach known in the related art involves expressing the planned travel route and a route other than the planned travel route, for example, in different colors, so that the planned travel route and the route other than the planned travel route are distinguishable from each other. Another approach known in the related art involves expressing a driving assistance section and a non-assistance section on a planned travel route in different presentation modes, so that the driving assistance section and the non-assistance section are distinguishable from each other. Still another approach known in the related art involves presenting lines indicative of, for example, the degree of traffic congestion and traffic restrictions on the side of a road. Suppose that another approach involves: presenting lines indicative of, for example, the degree of traffic congestion and traffic restrictions; and presenting a line indicative of a driving assistance section and a line indicative of a non-assistance section distinctively using different line types and/or colors. Such an approach, however, excessively increases the amount of information to be presented on a road or on the side of a road using the lines. This unfortunately makes it difficult for the driver to understand a point of switching between the driving assistance section and the non-assistance section.

To solve this problem, the present embodiment involves: presenting a line indicative of a driving assistance section on a planned travel route and a line indicative of a non-assistance section on the planned travel route in the same presentation mode; and presenting an icon indicating a point of switching between the driving assistance section and the non-assistance section on the planned travel route.

The guide controller 21c is a program module to cause the controller 20 to carry out the function of presenting an icon indicating a point of switching between a driving assistance section and a non-assistance section on a planned travel route. A function of the guide controller 21c causes the controller 20 to present a planned travel route in a presentation mode that makes the planned travel route distinguishable from other roads. As illustrated in FIGS. 2A to 2C, for example, the planned travel route is indicated by a gray thick line, and other roads are presented using default color(s). In other words, the present embodiment involves presenting both of a driving assistance section and a non-assistance section on a planned travel route using lines in the same presentation mode. Accordingly, the present embodiment is able to reduce, for the planned travel route, the amount of information to be expressed using lines and is thus able to provide necessary information to the user such that the user easily understands the necessary information.

A function of the guide controller 21c causes the controller 20 to present an icon indicating the starting point of the driving assistance section on the planned travel route such that the icon is located close to the starting point, and causes the controller 20 to present an icon indicating the end point of the driving assistance section on the planned travel route such that the icon is located close to the end point. The icons indicating the starting point and the end point may be any figures having shapes that are highly likely to enable the user to clearly understand the indicated points (i.e., target points). Accordingly, various types of icons may be conceivable. In one example, each icon may include a main portion containing information such as a character and/or a pattern, and a pin portion indicating a target point. As illustrated in FIG. 2A, the present embodiment is based on the assumption that each icon has a shape formed by a combination of a circle and a triangle, with the base of the triangle located inside the circle. The circle is equivalent to the main portion, and the triangle is equivalent to the pin portion. In the present embodiment, the controller 20 places each icon on a map such that a vertex of the pin portion is located on the associated target point, a line connecting the vertex of the pin portion and the center of the main portion is parallel to the up-down direction of the display, and the main portion is located above the pin portion in the up-down direction of the display.

For a point of switching from a non-assistance section to a driving assistance section on a planned travel route, the controller 20 presents an icon indicating that the point of switching is the starting point of the driving assistance section. For a point of switching from a driving assistance section to a non-assistance section on a planned travel route, the controller 20 presents an icon indicating that the point of switching is the end point of the driving assistance section. As illustrated in FIG. 2A, the present embodiment involves: causing the main portion of the icon indicating the node N₁ (which corresponds to the starting point of the driving assistance section) to contain a character “S” (which signifies the first letter of the word “start”), thus expressing the starting point; and causing the main portion of the icon indicating the node N₂ (which corresponds to the end point of the driving assistance section) to contain a character “E” (which signifies the first letter of the word “end”), thus expressing the end point.

As described above, the present embodiment involves presenting icons indicating points of switching between a driving assistance section and a non-assistance section on a planned travel route such that the icons are located close to the points of switching, thus guiding the user to the location of the driving assistance section on the planned travel route. The icons are visually different from lines presentable on the planned travel route and/or on the side of the planned travel route in various presentation modes. This is because each icon does not have an elongated shape extending in parallel with a road. The user is thus able to easily distinguish the icons from the lines. Consequently, the present embodiment is able to make it more likely for the user to easily understand that the positions indicated by the icons are points of switching between the driving assistance section and the non-assistance section. Guiding the driver to the location of the driving assistance section on the planned travel route also enables the driver to recognize the location of the non-assistance section on the planned travel route.

The process of guiding the driver to the driving assistance section and the non-assistance section on the planned travel route as described above may be performed when an entirety of the planned travel route is presented (or when all routes are presented) after a search for a route to a destination and before the start of travel, or may be performed when a map of an area around the current position of the vehicle C is presented during actual travel along the planned travel route after the planned travel route has been decided.

### (2) Driving Assistance Section Presenting Process

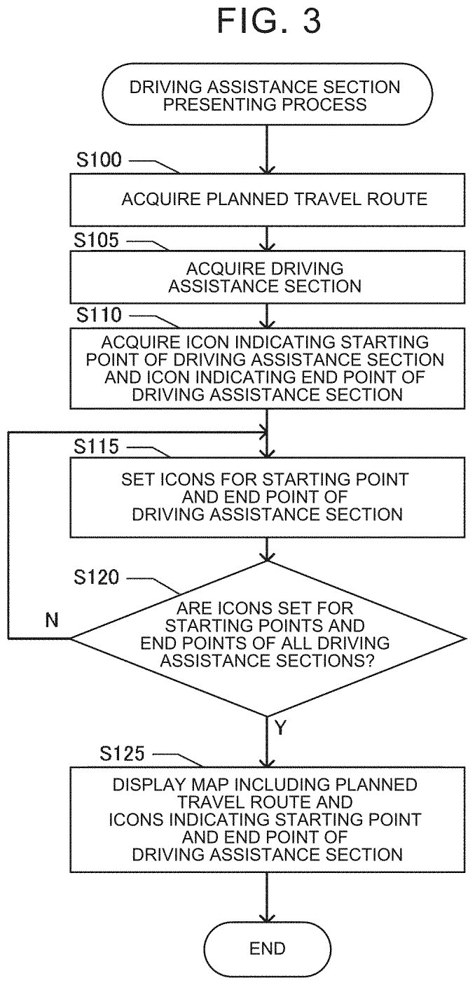

A driving assistance section presenting process to be performed by the controller 20 will be described below with reference to FIG. 3. The driving assistance section presenting process is a process for presenting a map including a planned travel route on the touch screen display of the user I/F unit 44, such that a driving assistance section and a non-assistance section on the planned travel route are distinguishable from each other. The driving assistance section presenting process illustrated in FIG. 3 is assumed to be performed when an occupant of the vehicle C has entered a destination through the user I/F unit 44 so as to issue an instruction for a route search.

In step S100, a function of the planned travel route acquirer 21a causes the controller 20 to acquire a planned travel route upon start of the driving assistance section presenting process. Specifically, the controller 20 acquires the current position of the vehicle C in accordance with output signals from the GNSS receiver 41, the vehicle speed sensor 42, and the gyroscope sensor 43. The controller 20 then makes reference to the map information 30a so as to make a search for a route from the current position to the destination. The controller 20 thus acquires the planned travel route as a result of the search.

In step S105, a function of the driving assistance section acquirer 21b causes the controller 20 to acquire a driving assistance section. Specifically, the controller 20 notifies the vehicle control system 45 about the planned travel route (which has been acquired in step S100) so as to acquire, from the vehicle control system 45, driving assistance availability information for road sections included in the planned travel route. In accordance with the driving assistance availability information, the controller 20 determines the positions of the starting point and end point of the driving assistance section included in the planned travel route. When the planned travel route includes a plurality of driving assistance sections located away from each other, the controller 20 acquires the starting points and end points of all of the driving assistance sections.

In step S110, a function of the guide controller 21c causes the controller 20 to acquire an icon indicating the starting point of the driving assistance section and an icon indicating the end point of the driving assistance section. Specifically, the controller 20 makes reference to the rendering data 30b in the recording medium 30 so as to acquire rendering data for the icon indicating the starting point and rendering data for the icon indicating the end point. The recording medium 30 may record a plurality of patterns of icons indicating the starting point and a plurality of patterns of icons indicating the end point, so that the user is able to select desired icons in advance.

In step S115, a function of the guide controller 21c causes the controller 20 to set the icons for the starting point and end point of the driving assistance section. Specifically, the controller 20 decides the position at which the icon indicating the starting point of the driving assistance section is to be rendered, and the position at which the icon indicating the end point of the driving assistance section is to be rendered. More specifically, the controller 20 decides to render the starting point icon acquired in step S110, such that a vertex of a pin portion of the starting point icon is located on the starting point of the driving assistance section (e.g., the node N₁ in FIG. 2A), a line connecting the vertex of the pin portion and the center of a main portion of the starting point icon is parallel to the up-down direction of the display, and the main portion is located above the pin portion in the up-down direction of the display. The controller 20 decides to render the end point icon acquired in step S110, such that a vertex of a pin portion of the end point icon is located on the end point of the driving assistance section (e.g., the node N₂ in FIG. 2A), a line connecting the vertex of the pin portion and the center of a main portion of the end point icon is parallel to the up-down direction of the display, and the main portion is located above the pin portion in the up-down direction of the display.

In step S120, a function of the guide controller 21c causes the controller 20 to determine whether the starting point icons and the end point icons have been set for all of the driving assistance sections. When the determination in step S120 indicates that the icons have not been set for all of the driving assistance sections, the process returns to step S115. When the determination in step S120 indicates that the icons have been set for all of the driving assistance sections, the process goes to step S125. In step S125, a function of the guide controller 21c causes the controller 20 to present: a map including the planned travel route; and the icons indicating the starting point and end point of each driving assistance section. Specifically, the controller 20 according to the present embodiment decides a scale that allows an entirety of the planned travel route to be located within a map presentation region of the display, and renders a map covering the entirety of the planned travel route to this scale in a map presentation region of the RAM. The controller 20 renders lines whose colors indicate the planned travel route, such that the lines are superimposed on the planned travel route rendered in the RAM. In the present embodiment, the controller 20 renders lines in the same presentation mode (e.g., lines of the same color, thickness, and/or line type) for both of the driving assistance section and the non-assistance section. The controller 20 renders the starting point icon (which indicates the starting point of the driving assistance section on the planned travel route) at the starting point icon rendering position decided in step S115, such that the icon is superimposed on the map. The controller 20 renders the end point icon (which indicates the end point of the driving assistance section) at the end point icon rendering position decided in step S115, such that the icon is superimposed on the map. In accordance with the data rendered in the map presentation region of the RAM, the controller 20 presents the map on the touch screen display of the user I/F unit 44.

When no driving assistance section is included in the planned travel route acquired in step S100, the controller 20 presents all sections of the planned travel route using lines in a presentation mode for the non-assistance section.

### (3) Other Embodiments

The embodiment described above is an example of carrying out various aspects of the present disclosure. The present disclosure may include various other embodiments. At least some of the functions of the planned travel route acquirer 21a, the driving assistance section acquirer 21b, and the guide controller 21c included in the driving assistance system, for example, may be included separately in a plurality of devices. One or some of the functions of the planned travel route acquirer 21a, for example, may be implemented by a server. One or some of the functions of the driving assistance section acquirer 21b and/or one or some of the functions of the guide controller 21c may be implemented by the vehicle control system 45. One or some of the components or elements described in the foregoing embodiment may be naturally optional. The order in which the steps of the driving assistance section presenting process are to be performed may be changed. One or some of the steps of the driving assistance section presenting process may be optional.

The planned travel route acquirer may be any planned travel route acquirer that is able to acquire a planned travel route for the vehicle. The planned travel route may be any route that has a higher possibility for travel of the vehicle than other routes. The planned travel route may be, for example, a route that allows the vehicle to travel along the route from the current position, or a route leading to a destination set by the user. The planned travel route may be an optimal route for which a search is made by a known route search method. The planned travel route may be a route set by the navigation system installed in the vehicle, or may be a route set by a server that is able to communicate with the vehicle.

The driving assistance section acquirer may be any driving assistance section acquirer that is able to acquire a driving assistance section on a planned travel route. Information indicative of the driving assistance section may have any data structure that enables identification of the starting point and end point of the driving assistance section and the starting point and end point of the non-assistance section. In the foregoing embodiment, reference is made to the vehicle control map information 45a so as to acquire information indicative of the driving assistance section. The aspects of the present disclosure, however, is not limited to this method. The map information 30a and the vehicle control map information 45a may be combined in the vehicle C. Information indicative of the driving assistance section may be acquired from a server each time a route search is made or a route guide is provided.

The driving assistance section may be any road section in which the predetermined level of driving assistance control is exercisable. The non-assistance section may be any road section in which the predetermined level of driving assistance control is not exercisable. Various types of driving assistance control may be exercisable in the driving assistance section. Various types of control may be exercisable in the non-assistance section. In an alternative to the embodiment described above, control of Level 3 or 4, for example, may be exercised in the driving assistance section, and control of level 0 (i.e., fully manual driving), for example, may be exercised in the non-assistance section. Control of Level 1 or higher level, for example, may be exercised in the driving assistance section, and control of level 0 (i.e., fully manual driving), for example, may be exercised in the non-assistance section.

The driving assistance control may involve exercising control to assist the driver in accelerating and decelerating the vehicle, or may involve exercising control to assist the driver in steering the vehicle. The driving assistance control may be exercised in accordance with detection information obtained by any of various sensors mounted on the vehicle. Examples of the various sensors may include an image sensor, a radar, and a sound wave sensor.

The guide controller may be any guide controller that enables presentation of icons indicating points of switching between a driving assistance section and a non-assistance section on a planned travel route. Each icon may be any figure having a shape that is highly likely to enable the user to clearly understand the indicated point (i.e., a target point). Each icon may include a main portion and a pin portion as in the foregoing embodiment, or may consist of a pin portion without any main portion. The main portion may have any shape that is able to contain a pattern and/or a character. The main portion does not necessarily have to contain a pattern or a character. The pin portion does not necessarily have to be a triangle. The pin portion may be, for example, an arrow indicating the starting point of the driving assistance section and pointing in a direction perpendicular to the direction of extension of the driving assistance section in an area adjacent to the starting point of the driving assistance section. The pin portion may be an arrow indicating the end point of the driving assistance section and pointing in a direction perpendicular to the direction of extension of the driving assistance section in an area adjacent to the end point of the driving assistance section.

The icon indicating a point of switching from the non-assistance section to the driving assistance section on the planned travel route may be an icon indicating that the point of switching is the starting point of the driving assistance section. The icon indicating a point of switching from the driving assistance section to the non-assistance section on the planned travel route may be an icon indicating that the point of switching is the end point of the driving assistance section. As illustrated in FIG. 2B, for example, the starting point and the end point may be expressed by presenting the icons in different colors. The color for the starting point and the color for the end point may be selectable by the user. As illustrated in FIG. 2C, for example, the starting point and the end point may be expressed by presenting the icons with arrows indicating the direction of travel along the driving assistance section.

The inventive approach to presenting icons indicating points of switching between a driving assistance section and a non-assistance section on a planned travel route may be used as a program or a method. The system described above may be built in the form of a single device or may be built by using shared components included in a vehicle. The system may thus be built in various forms. The program and method descried above may be executed by a single device or may be executed by using shared components included in a vehicle. The program and method may thus be executed in various manners. Modifications may be made to the present disclosure as appropriate. For example, the system may be partly software and partly hardware, and the program and method may be executed partly by software and partly by hardware. Aspects of the present disclosure may be implemented in the form of a recording medium storing a system control program. The program recording medium may naturally be a magnetic recording medium or a semiconductor memory. The program recording medium may be any of recording media to be developed in the future.

What is claimed is:

1. A driving assistance system comprising:
a planned travel route acquirer to acquire a planned travel route for a vehicle;
a driving assistance section acquirer to acquire a driving assistance section on the planned travel route; and
a guide controller to present at least one icon indicating a point of switching between the driving assistance section and a non-assistance section on the planned travel route.

2. The driving assistance system according to claim 1, wherein
when presenting an entirety of the planned travel route, the guide controller presents the at least one icon indicating the point of switching between the driving assistance section and the non-assistance section on the planned travel route.

3. The driving assistance system according to claim 1, wherein
the at least one icon includes a first icon and a second icon,
the first icon indicates a point of switching from the non-assistance section to the driving assistance section on the planned travel route, the first icon indicating that the point of switching is a starting point of the driving assistance section, and
the second icon indicates a point of switching from the driving assistance section to the non-assistance section on the planned travel route, the second icon indicating that the point of switching is an end point of the driving assistance section.

4. The driving assistance system according to claim 2, wherein
the at least one icon includes a first icon and a second icon,
the first icon indicates a point of switching from the non-assistance section to the driving assistance section on the planned travel route, the first icon indicating that the point of switching is a starting point of the driving assistance section, and
the second icon indicates a point of switching from the driving assistance section to the non-assistance section on the planned travel route, the second icon indicating that the point of switching is an end point of the driving assistance section.

5. A driving assistance program for causing a computer to function as:
a planned travel route acquirer to acquire a planned travel route for a vehicle;
a driving assistance section acquirer to acquire a driving assistance section on the planned travel route; and
a guide controller to present at least one icon indicating a point of switching between the driving assistance section and a non-assistance section on the planned travel route.
